(19) United States
(12) Patent Application Publication
(10) Pub. No.: US 2004/0220826 A1
(43) Pub. Date: Nov. 4, 2004

(54) Methods for acquiring, and for displaying predictions of, subjective consumer-appraisals of items

(76) Inventor: John B. Hey, Weston, MA (US)

Correspondence Address: Brian M. Dingman, Mirick, O'Connell, DeMallie & Lougee, LLP, 1700 West Park Drive, Westborough, MA, 01581-3941, US

(21) Appl. No.: 10/760,657

(22) Filed: Jan. 20, 2004

Related U.S. Application Data
(60) Provisional application No. 60/443,396, filed on Jan. 29, 2003.

(51) Int. Cl. G06F 17/60

(52) U.S. Cl. 705/1; 705/10

(57) ABSTRACT

A method for acquiring, and for displaying predictions of, subjective consumer-appraisals of items. The method allows a consumer to insert the item into an ordered list of his previously appraised items, so that the list continues to reflect his relative preference of the listed items. Likewise, the appraisal value predicted for a given consumer and item is displayed as its anticipated position on an ordered list of the consumer's previously appraised items.

### CROSS REFERENCE TO RELATED APPLICATION

This application claims benefit of Provisional application entitled “Methods for Acquiring, and for Displaying Predictions of, Subjective Consumer-Appraisals of Items”, serial No. 60/443,396, filed on Jan. 29, 2003.

### FIELD OF THE INVENTION

The present invention relates to methods for allowing a consumer to express his subjective appraisal of items he has consumed, and for displaying to an item's prospective consumer a prediction of his subjective quantitative appraisal of the item.

### BACKGROUND OF THE INVENTION

A given consumer's reaction to a given item may strongly depend upon the consumer's subjective, non-obvious tastes. For many item categories, therefore, predicting that reaction is problematic, even when detailed objective item-descriptions are available beforehand. Common examples of such categories include movies, books, and music. Still, the many consequences of wrongly chosen items make reliable individual predictions highly desirable. E.g., when informed by such predictions, trips to the multiplex now find the “better” movies, and fewer novels disappoint.

Since 1985, some popularity has been afforded a computer-oriented approach to predicting consumers' subjective reactions to items. With that approach, each consumer rates items already consumed, by placing each item on a fixed scale ranging from, e.g., “10” to “1”, or “good” to “bad”. The recorded set of the consumer's ratings comprises the indication of that particular consumer's tastes, which the computer then analyzes vs. the rating-sets of other consumers, in order to predict the original consumer's probable rating of a prospective item. (Many kinds of analyses are possible. For example, if two consumers have rated many items in common, and furthermore have rated each item similarly, then the computer might consider each consumer's additional item-ratings to strongly predict the other consumer's prospective rating of those items.) The predicted rating is typically displayed as a value on the same scale.

With such computer-oriented predictors, the acquisition of a consumer's subjective item-rating comprises the consumer's direct assignment of a scalar value to the item in question, from a static scale of possible values (or range of values).

One weakness of the static scale is that many consumers can't readily resolve it to their own innate sense of item quality (even if the scale is marked with verbal “hints”, e.g., Good, Fair, Poor). And even consumers who do feel comfortable with such a scale often misuse it. For example, they typically mis-assign their first items, by not placing them on the scale where they'll later wish they had, after rating additional items. Then, the consumer must either re-rate some items or else be resigned to a continuing misuse of the scale.

Another weakness of the static scale arises from consumers' tendency to inflate (particularly) its outlying values by rating recently consumed items “enthusiastically”, i.e., overly high or low. A static scale panders to such abuse, by offering a seemingly inexhaustible supply of all scale values. (This is somewhat analogous to the classroom practice of “grade inflation”.)

A further weakness of the static scale arises because the subjective “feeling” that a consumer associates with (say) the middle value of the scale readily varies over weeks and months, thereby compromising his appraisals' accuracy as a consistent representation of his tastes.

Still another weakness of the static scale is especially prominent in the movie recommendation system proffered by online DVD-renter, Netflix, Inc., whose consumers rate movies (DVDs) on a scale of merely five points. (Other rating systems use as many as a hundred.) Presumably, Netflix intends to unburden its consumers of having to discern subtle differences in their subjective enjoyment of movies. But, regardless of how unburdened the consumer may feel, the need for subtle discernment nevertheless remains. For example, when the consumer feels that a movie merits the unavailable appraisal of “four-and-a half”, not only must a reason be fabricated for awarding, say, the “five” rather than the “four”, but the choice is quite critical because it spans a full 20% of the five-point appraisal scale. In defense of Netflix's system, meanwhile, note that a rating scale of, say, a hundred possible values (or worse, a “continuous” scale) obviously overwhelms many consumers.

Importantly, weaknesses such as the above not only compromise consumers' ability to rate items accurately, but also degrade the accuracy of a computer's predictions subsequently based upon those ratings.

### SUMMARY OF THE INVENTION

Taking the above into consideration, an object of the present invention is the acquisition, in a manner convenient to consumers, of a consumer's accurate subjective appraisal of a consumed item.

Another object of the present invention is the display of a consumer's predicted appraisal of an item, in a manner intuitively comprehensible to the consumer.

For systems that collect and predict subjective item-appraisals, the present invention provides a new means for a consumer to arrive at and to specify to the system each appraisal, as well as a new and related means by which the system may present its predictions to the consumer.

In one illustrative embodiment, the consumer, using his computer system's keyboard and monitor, selects for appraisal several items he's already consumed. He then rearranges a list of the selected items to reflect his relative subjective appraisal of each item, e.g., ordering them from “best” to “worst”. Later, when he wants to appraise an additional item, he retrieves his ordered list and inserts the new item at a position reflecting his appraisal. If two or more items are “equal” in his view, he may place them at effectively the same list position.

When the system predicts the consumer's appraisal of an item (usually an item he hasn't yet consumed), the prediction is shown as a position (or range of positions) on his list. The present invention also includes a method for displaying an item's prediction as a “graded” range, which depicts an increasingly narrow, and decreasingly reliable, value range for the predicted appraisal.

A variation of the preceding embodiment allows the consumer to adjust the space between adjacent items on his list, to reflect the degree of difference in their appraised “goodness”.

Some advantages of the present invention are already apparent:

The consumer need never connect his sense of an item's worth to a number on an arbitrary scale. Rather, he merely decides which of (say) two items he liked more . . . an intuitive task he can easily perform with consistent accuracy (unlike the task of quantifying his enjoyment as an absolute value).

He can express his perceived spectrum of item-quality as coarsely or finely as he chooses, because, e.g., he can always insert a new item at an “in-between” position. He need never attempt a prescient apportionment of a rating scale, because each newly entered item can always be inserted simply and exactly in relation to his already entered items, thus easily accommodating his opinions' full breadth and granularity as they evolve over time.

When appraising a new item, he is automatically made aware of the “meaning” of whatever list position he chooses. E.g., he's likely to consider carefully whether he truly enjoyed the new item more than its next-lower neighbor . . . and the answer is readily forthcoming, requiring merely that he remember the other item well enough to realize which one he liked more.

(Note that the preceding advantages facilitate the consumer's accuracy in presenting appraisals to the system.)

Analogous advantages apply to the system's display of a predicted item-appraisal as a list position. For example, the consumer grasps a prediction's true meaning through his memories of its adjacent list items, i.e., items he has already appraised and “understands”. Such intuitive comfort with a numerical scale arrives only over time, if ever. Furthermore, because the list directly reflects the consumer's individual appraisal tendencies (e.g., with respect to granularity, or thresholds of item-worthiness), an item's predicted list position means even more to an individual consumer, by resonating more closely with his internal tastes.

The above and other objects, features, and advantages of the present invention will become apparent from the following description, taken in conjunction with the accompanying drawings which illustrate preferred embodiments of the present invention by way of example.

### BRIEF DESCRIPTION OF THE DRAWINGS

FIGS. 1A and 1B show an example of a prior art arbitrary scale of values;

FIG. 2 is a flow chart of a typical opinion-predicting system that can be used with the invention;

FIGS. 3A-3C depict a list of previously-appraised movies and a user's insertion of a newly-appraised movie into the list, according to the invention;

FIGS. 4A and 4B depict a list of previously-appraised movies and two alternative manners in which a prediction relating to another movie can be presented to the user, according to the invention;

FIGS. 5A-5D depict a list of previously-appraised movies and different embodiments of a user's insertion of a newly-appraised movie into the list, according to the invention; and

FIGS. 6A-6E depict a list of previously-appraised movies and several alternative manners in which a prediction relating to another movie can be presented to the user, according to the invention.

### DETAILED DESCRIPTION OF THE PREFERRED EMBODIMENTS

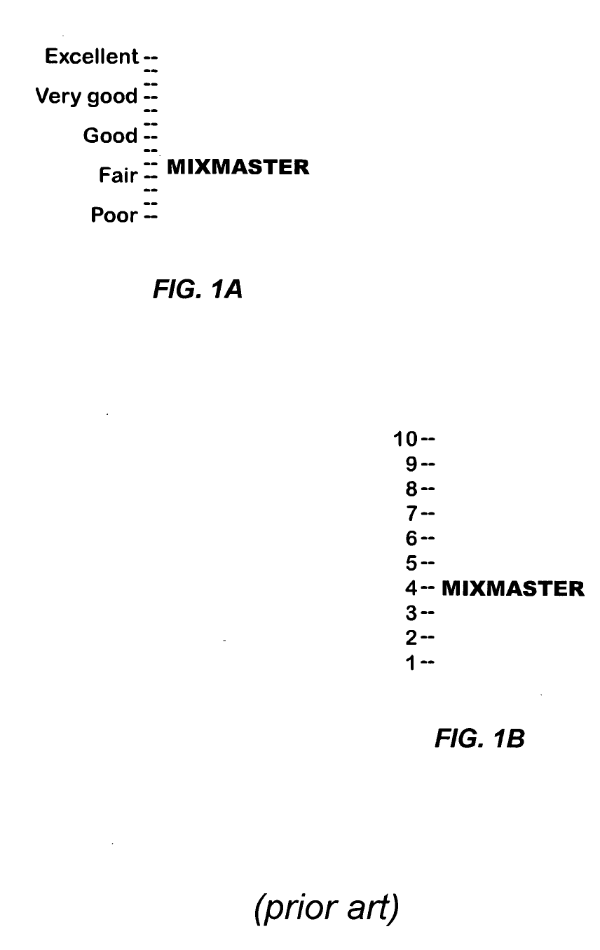

Prior to the present invention, the consumer appraises a movie he's watched by effectively assigning it a position on an arbitrary scale of values, e.g., 1-10, Poor-Fair-Good-Excellent, or Thumbs Up-Level-or-Down, as exemplified in FIGS. 1A and 1B. The position he assigns is supposed to reflect his subjective appraisal of the movie. He therefore must choose, and somewhat memorize, how to apportion the scale with respect to his own past (and future) personal movie experiences. And he must choose well because, e.g., ill-chosen assignments of his initially entered movies can effectively confine his later movie ratings (and resultant predictions) to a tiny segment of the scale.

Certain preferred embodiments of the present invention will now be described in conjunction with the accompanying drawings.

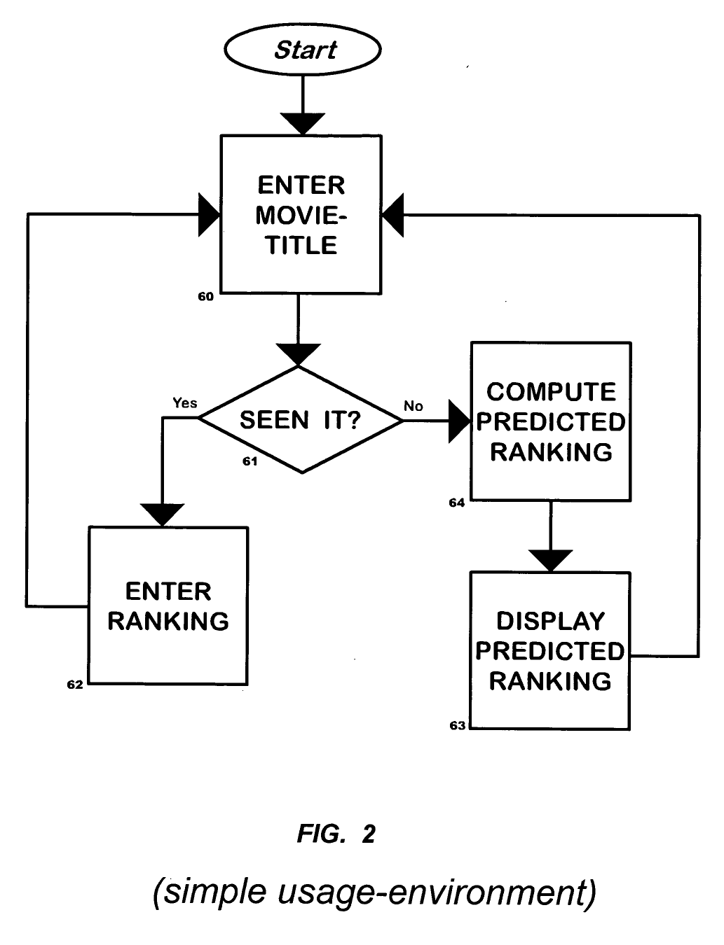

FIG. 2 illustrates a typical opinion-predicting system, in the item domain of movies. In this environment, a consumer identifies a movie of interest 60. If he has already watched the movie 61, he enters his subjective appraisal of it 62. If, however, he hasn't watched it, a prediction of how high his appraisal of the movie would be is computed 64, and displayed to him 63. The present invention concerns how he enters his appraisals 62, and how predictions are displayed to him 63.

Note that the prediction methodology 64 may range from the trivial to the intricate, and that the present invention is independent of any particular such methodology. (A primitive methodology might notice, for example, that most consumers who've rated both movie-A and -B have furthermore given them similar ratings; so, a new consumer who rates movie-A low would be predicted to rate movie-B low, too. Naturally, much more sophisticated methodologies are possible.)

### FIRST EXAMPLE PREFERRED EMBODIMENT OF THE INVENTION

Using a computer screen and keyboard, a consumer wishes to enter his personal appraisal of movies he's recently watched (or books he's recently read, or music he's recently heard, for example). By doing so, he intends to inform an underlying computer program of his personal taste in movies, so that he can later receive from the program accurate predictions of his appraisals of movies he hasn't yet watched. Because such predictions are (typically) based upon an inter-personal analysis of many such appraisals entered by many such consumers, the consumer wants his entries to reflect accurately his true movie tastes, so that the program's resulting predictions for him will be likewise accurate and reliable.

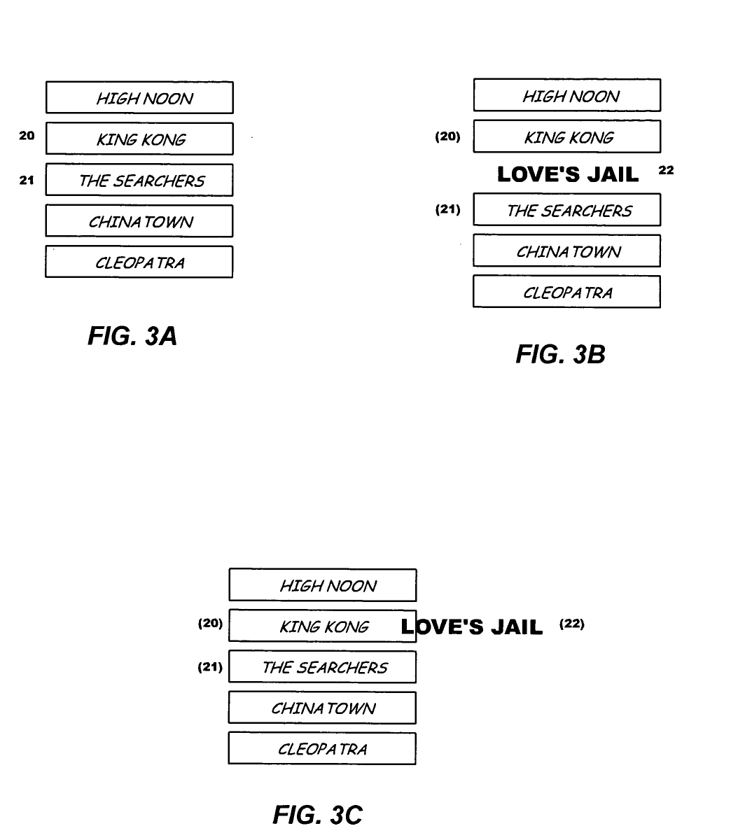

For this example embodiment, consider a consumer who has already entered his relative appraisals of several movies he's seen, and who now wishes to enter a new movie appraisal. Accordingly, he is shown his current list, ordered “best”-to-“worst” (FIG. 3A). After some reflection, he realizes that he enjoyed the new movie (entitled “Love's Jail”) less than the second listed movie 20, but more than the third listed movie 21. He therefore inserts the new movie 22 into the list, placing it into the “gap” between those two movies (FIG. 3B).

Alternatively, he may insert the new movie exactly upon an already listed movie (FIG. 3C), thereby equating them. The consumer may at any time rearrange the movies comprising his current list, thereby revising his earlier entered appraisals of them.

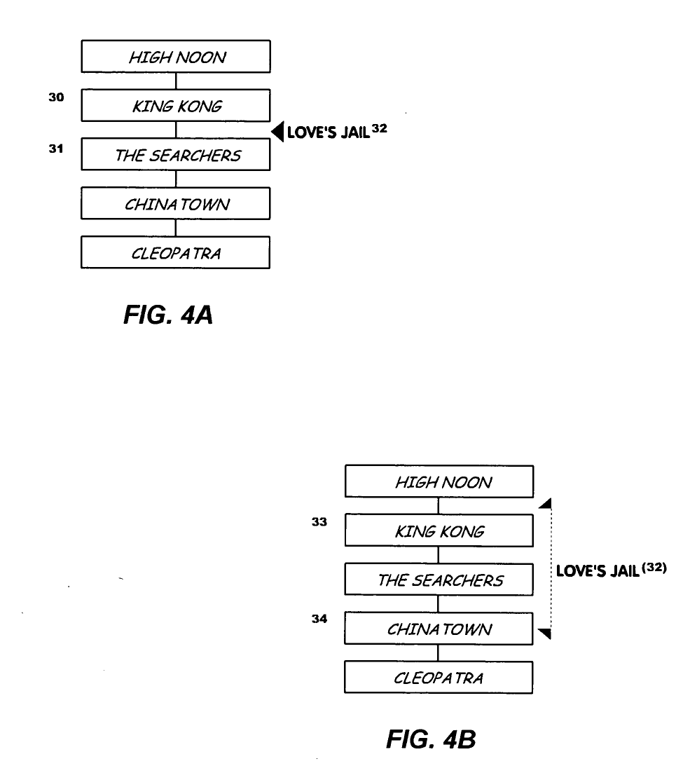

In return for entering his movie appraisals, the consumer hopes ultimately to receive a meaningful prediction (as calculated by a computer program) of his opinion of one or more movies he hasn't yet seen. The present invention presents such a prediction using an ordered list comprising movies he has previously entered. As exemplified in FIG. 4A, the consumer's enjoyment of his unseen movie 32 is predicted to lie between that of his already seen-and-entered movies 30 and 31. The prediction may alternatively encompass a range of positions; the example in FIG. 4B predicts (using a bracket or another icon) that the consumer's enjoyment would lie somewhere between exceeding movie 33 to equaling movie 34.

### SECOND EXAMPLE PREFERRED EMBODIMENT OF THE INVENTION

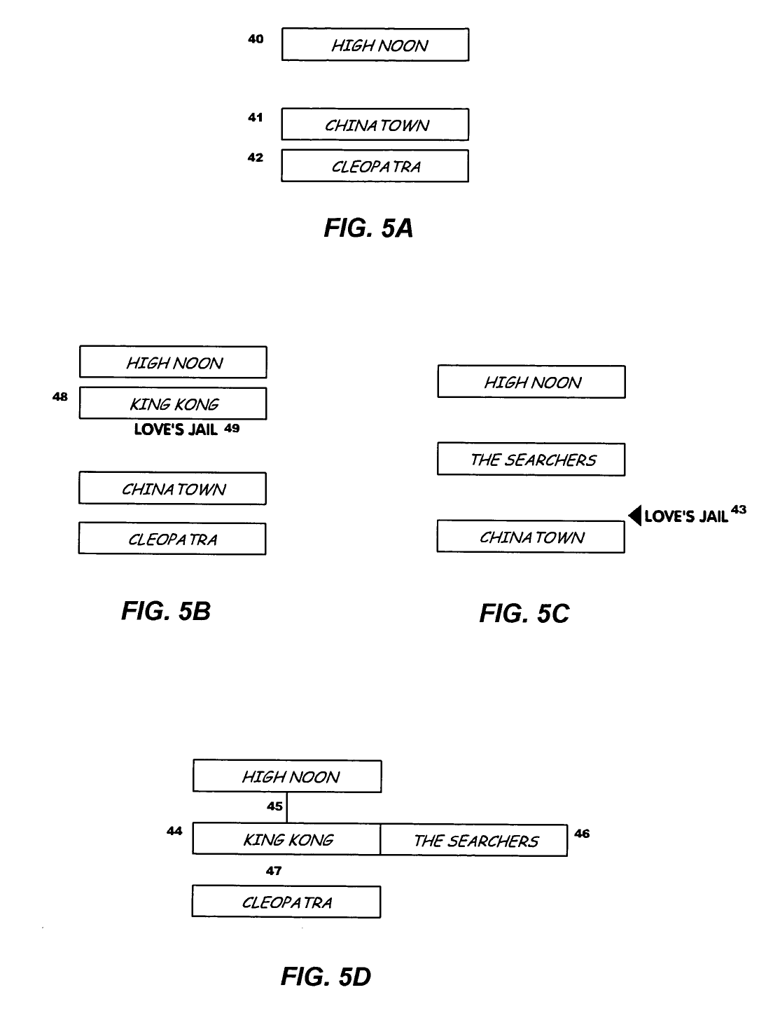

In a further embodiment, the scale (comprising the list of the consumer's previously entered movies, ordered by his enjoyment of them) indicates also the relative enjoyment “distance” between adjacent movies. For example, in FIG. 5A the consumer enjoyed movie 40 much more than movie 41, and thus the gap between them is large. Meanwhile, he enjoyed movie 41 only slightly more than movie 42, and thus the gap between them is small. In such an embodiment, a consumer may accordingly refine his opinion of an entered movie. For example, in FIG. 5B he has judged the new movie 49 to be only slightly inferior to the better movie 48; thus his placement of the new movie leaves movies 48 and 49 almost touching. (For example, a typical computer drag-and-drop interface permits the consumer to drag movie-title 49 upwards until it nearly touches movie-title 48.)

Similarly, this embodiment displays a prediction by placing it appropriately nearer the top or bottom of its gap. For example, in FIG. 5C because the consumer's enjoyment level is predicted to be rather nearer the bottom movie of its gap, the prediction 43 is placed proportionally further down the gap.

More generally, in such embodiments the gap shown between two movies reflects the consumer's relative enjoyment “distance” between them. However, note that not merely actual space, but virtually any informational characteristic can be employed to convey a gap's size. FIG. 5D illustrates an example embodiment that does not vary shown distances, using instead the presence or absence of a connector to liken adjacent movies. The movie scale shown indicates that the consumer enjoyed movie 44 only marginally less than movie above (hence the connector at 45), but distinctly more than the movie below (hence no connector at 47), and exactly as much as the (sideways contiguous) movie 46.

### THIRD EXAMPLE PREFERRED EMBODIMENT OF THE INVENTION

The present invention includes also a method of displaying a prediction on practically any ordered scale (including scales claimed by the present invention). According to this method, the consumer is shown a “graded” range of values (i.e., with each value graded according to its predicted likelihood) comprising the prediction of his enjoyment of the movie.

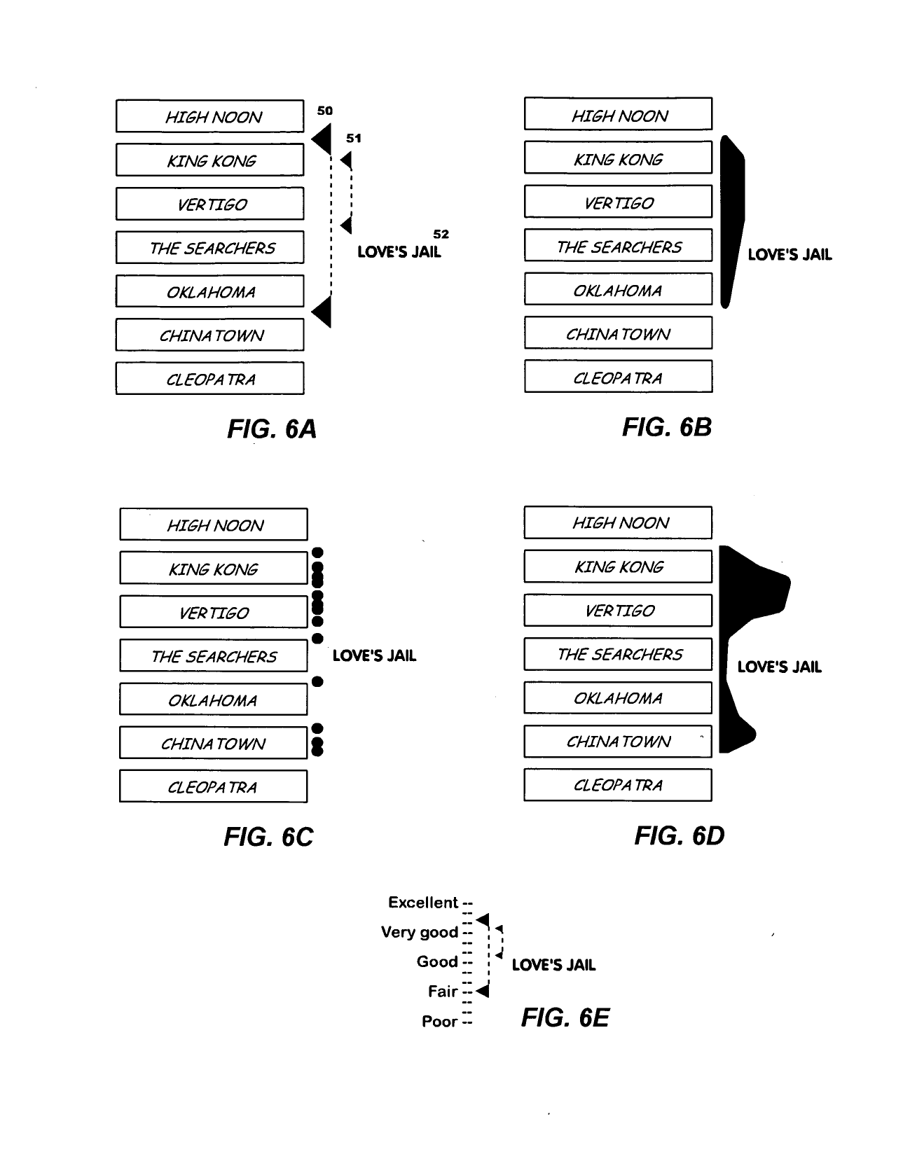

For example, in FIG. 6A the full prediction comprises a high confidence (“tier” 50 with relatively large arrows at the ends) that the consumer would give the movie 52 an appraisal between very-high and moderately-low, and a lower confidence (tier 51 with smaller arrows at the ends) that his appraisal will lie toward the upper end of that range. Alternatively, such tiers of probable ranges can be smoothed to an approximation having a different appearance, for example as illustrated by FIG. 6B, which approximates the combined prediction shown in FIG. 6A.

By way of further example, the prediction may comprise a “scatter plot” indicating the relative probability assigned to one or more scale areas, as exemplified in FIG. 6C. Such a scatter-plot prediction may likewise be approximated in a smoothed display as illustrated by FIG. 6D.

FIG. 6E exemplifies a graded prediction applied to an ordinary fixed and static scale of possible appraisal values (cf FIG. 6A).

Note that the display or presentation of a list can alternatively occur on a document printed by the computer system.

What is claimed is:

Other embodiments will occur to those skilled in the art and are within the following claims:

What is claimed is:

1. A method for acquiring a consumer's subjective appraisal of an item of a type of which the consumer has previously appraised one or more items, comprising:
presenting to the consumer a list of items previously appraised by the consumer, ordered by the consumer's appraised values; and
allowing the consumer to indicate a position along the presented list which corresponds to the consumer's appraisal of the new item relative to the items in the presented list.

2. The method of claim 1, used to acquire item appraisals for a computerized appraisal prediction system.

3. The method of claim 1, in which:
the relative difference between the consumer's appraised-values of adjacent listed items is also indicated in the presented list; and
the consumer may adjust the relative difference between adjacent listed items, to refine accordingly the consumer's appraised difference between the items.

4. The method of claim 1, in which allowing the consumer to indicate a position along the list includes allowing the consumer to place a description of the new item above or below an item, or between two items, that had been previously been appraised by the consumer.

5. The method of claim 1, in which allowing the consumer to indicate a position along the list includes allowing the consumer to place a description of the new item at the same position in the list as an item that had been previously been appraised/by the consumer.

6. The method of claim 1, in which the items comprise movies.

7. The method of claim 1, in which the items comprise books.

8. The method of claim 1, in which the items comprise sound recordings.

9. A method for displaying a prediction of a consumer's subjective appraisal of an item of a type of which the consumer has previously appraised one or more items, comprising:
presenting to the consumer a list of items previously appraised by the consumer, ordered by the consumer's appraised values; and
Indicating a list position which corresponds to the appraisal value predicted for the item relative to the other items in the list.

10. The method of claim 9, in which indicating a list position includes placing a description of the new item between two items in or proximate the list.

11. The method of claim 9, in which indicating a list position includes placing a description of the new item at the same list position as another item in the list.

12. The method of claim 9, in which the items comprise movies.

13. The method of claim 9, in which the items comprise books.

14. The method of claim 9, in which the items comprise sound recordings.

15. A method for displaying a prediction of a consumer's subjective appraisal of an item of a type of which the consumer has previously appraised one or more items, comprising:
presenting to the consumer a scale or range of possible values for the consumer's appraisal of the item; and
indicating to the consumer a probability value associated by the prediction with each scale value or range of values.

16. The method of claim 15, in which a continuous range of probabilities is indicated for a continuous range of scale values.

17. The method of claim 15, in which the probability value is indicated at least in part through presentation of multiple scales or ranges of possible values.

18. The method of claim 15, in which the probability value is indicated at least in part through the relative size of a display icon.
